(19) United States
(12) Patent Application Publication
(10) Pub. No.: US 2007/0108907 A1
(43) Pub. Date: May 17, 2007

(54) Lower structure of plasma display panel, method for fabricating the same and plasma display panel with the same

(75) Inventors: Bum joo Lee, Seongnam-si (KR); Yoon young Choi, Seongnam-si (KR); Boong joo Lee, Bucheon-si (KR); Kyung wha Lee, Seoul (KR); Jae sang Chung, Seongnam-si (KR)

Correspondence Address: KED & ASSOCIATES, LLP, P.O. Box 221200, Chantilly, VA, 20153-1200, US

(73) Assignee: LG Electronics Inc.

(21) Appl. No.: 11/599,429

(22) Filed: Nov. 15, 2006

(30) Foreign Application Priority Data
Nov. 17, 2005 (KR) 10-2005-0110240

(51) Int. Cl. H01J 17/49

(52) U.S. Cl. 313/582

(57) ABSTRACT

A lower structure of plasma display panel, a method for fabricating the same and a plasma display panel with the same are disclosed, wherein the lower structure of a plasma display panel comprising: an address electrode formed on a lower substrate; a dielectric layer formed on the lower substrate for covering the address electrode; a barrier rib formed on the dielectric layer to form a discharge cell, with a width of a central portion thereof being narrower than each width of its upper and lower ends; and a fluorescent layer formed inside the discharge cell, such that. a discharge space increases to reduce a high temperature erroneous discharge and enhance reliability of the plasma display panel.

### CROSS-REFERENCE TO RELATED APPLICATION

This application claims the benefit of the Korean Patent Application No. 10-2005-0110240, filed on Nov. 17, 2005 in Korea, which is hereby incorporated by reference.

### BACKGROUND

This description relates to a lower structure of plasma display panel, a method for fabricating the same and a plasma display panel with the same.

Generally, a plasma display panels (PDP) is a flat panel display that displays images using a gas discharge phenomenon. The PDP is one of the commercially successful display devices featuring a wide range of sizes including, but not limited to, a graphic display of boasting of a diagonal screen size in excess of one meter with 2 million pixels.

The PDP has advantages that it has a very strong non-linearity to the discharge, does not discharge below an ignition voltage and has no limit in the number of lines, such that it is possible to be made into a high definition screen and bigger in size and employ a multiplex technology for reducing the number of driving circuits. The PDP also has advantages that its lifespan is longer and it is more simply structured than a cathode ray tube (CRT), has a higher luminescence and luminescence efficiency, and it is easy to manufacture. Because of these and other advantages, the PDP is rapidly demanded and spotlighted in response to sudden expansion of information society.

The PDP can be largely categorized into two types based on the types of driving voltage applied to discharge cells, i.e., an alternating-current (AC) type and a direct-current (DC) type. The AC type, generally recognized as the most suitable for wide-screen application, is fast becoming the norm. The AC type PDP, if more specifically explained, is such that charged particles, generated during discharge phenomenon when each sustain electrode is separated from a discharge layer by a dielectric layer and a protective layer, are not absorbed by the sustain electrodes to form wall charges, and subsequent discharges are generated by the wall charges.

The term “wall charges” as used herein refers to charges that are formed on a wall of discharge cells neighboring each electrode and accumulated to electrodes. Although the wall charges do not actually touch the electrodes, it will be described that the wall charges are “generated”, “formed”, or “accumulated” thereon.

FIG. 1 is an exploded perspective view illustrating a schematic configuration of a conventional AC plasma display panel.

Referring to FIG. 1, the plasma display panel comprises: a lower substrate (110); an address electrode (111) formed on the lower substrate (110); a dielectric layer (112) formed on the lower substrate (110) formed with the address electrode (111); a barrier rib (113) formed on the dielectric layer (112) for sustaining a discharge distance and for preventing electrical cross-talk between cells; a sustain electrode pair (114, 115), each having a predetermined pattern, for being coupled with the lower substrate formed with the barrier rib (113) and for crossing the address electrode (111); and an upper substrate (116) formed underneath a bus electrode pair (114a, 115a).

The sustain electrode pair is employed for allowing light to pass through, and is generally coupled with bus electrodes for compensating a high resistance of transparent electrodes. At least one lateral surface in an inner space partitioned by the barrier rib is formed with a fluorescent (phosphor) layer (117). The sustain electrode pair and the bus electrode pair are formed thereunder with a dielectric layer (118) in which electrodes are buried and a protective film (119). The inner space is filled with a discharge gas, which may include a Ne—Xe inert gas mixture.

In a case that images are realized in the PDP, a discharge start voltage is applied to electrodes, and plasma discharge occurs on the protective film. At this time, magnitude of the applied voltage may be determined by a gap of the inner space formed by front and rear lower substrates, kind and pressure of discharge gas introduced into the inner space, and attributes of the dielectric layer and protective film. Positive ions and electrons within the inner space moves with mutually opposite polarizations during the plasma discharge, such that a surface of the protective film is divided into two regions of one pair each having an opposite polarization. The wall charges remain on the surface of the protective film because the protective film is an insulation body having a high resistance. As a result, the AC type PDP has an intrinsic memory function, where the discharge is sustained at a voltage lower than the discharge start voltage due to influence by the wall charge.

The temperature inside the discharge cells in the PDP increases due to factors such as heat and ultraviolet rays emitted by the discharges. If the temperature inside the discharge cells increases, energy of particles existing inside the cells increases to activate the particles and to thereby promote the coupling of the positive charges and negative charges. Furthermore, the wall charges that are not involved with the memory function, i.e., the wall charges on the lateral surface of the barrier ribs and on the surface of the lower dielectric layer, increase to thereby allow forming an electric field, such that the wall charges either on the lateral surface of barrier ribs or on the surface of the lower dielectric layer couple with the positive charges or negative charges formed on the protective film.

When the coupling between the positive and negative charges decreases a potential generated by the wall charges, and the potential of the discharge cells is reduced to below the discharge sustain voltage, there occurs a phenomenon, so-called a high temperature erroneous discharge where discharges do not occur.

As one of the methods for reducing the high temperature erroneous discharge, a method of reducing the number of sustain waveforms is employed in response to a measured temperature in time of the PDP by installing a temperature measuring device on the PDP. However, the method suffers from degradation of luminescence.

In order to solve the afore-mentioned drawback, necessity arises for development of a PDP that can prevent the high temperature erroneous discharge that does not entail the degradation of luminescence.

### SUMMARY

This description has been disclosed to solve the above-identified drawback. An object is to provide a lower structure of plasma display panel, a method for fabricating the same and a plasma display panel with the same, by which a discharge space inside discharge cells are increased to reduce the high temperature erroneous discharge.

In one general aspect, a lower structure of a plasma display panel comprises: an address electrode formed on a lower substrate; a dielectric layer formed on the lower substrate for covering the address electrode; a barrier rib formed on the dielectric layer to form a discharge cell, with a width of a central portion thereof being narrower than each width of its upper and lower ends; and a fluorescent layer formed inside the discharge cell.

Implementations of this aspect may include one or more of the following features.

The width of the central portion of the barrier rib is in the range of 0.9˜0.7 times the width of the upper end.

The dielectric constant of the barrier rib is in the range of 1˜10.

The barrier rib comprises: a high dielectric layer having a dielectric constant of 11˜15; and a low dielectric layer formed on the high dielectric layer and having a dielectric constant in the range of 1˜10.

The dielectric layer is a white back for reflecting light emitted from the fluorescent layer.

The height of the barrier rib is in the range of 95˜145 μm.

The width of the upper end of the barrier rib is in the range of 30˜60 μm, and the width of the lower end of the barrier rib is in the range of 30˜100 μm.

In another general aspect, a method for fabricating a lower structure of a plasma display panel comprises: forming an address electrode on a lower substrate; applying a dielectric paste on the lower substrate to encompass the address electrode; pressing the dielectric paste by stamp to form a barrier rib having a width of a central portion thereof narrower than that of an upper end and a lower end; separating the dielectric paste from the stamp to fire the dielectric paste and to complete a dielectric layer and a barrier rib; and forming a fluorescent layer on a top surface of the dielectric layer and a lateral surface of the barrier rib.

In still another general aspect, a plasma display panel comprises: an upper structure formed under an upper substrate with a sustain electrode, a bus electrode, a dielectric layer and a protective film; and a lower structure coupled with the upper structure, wherein the lower structure comprises: an address electrode formed on a lower substrate; a dielectric layer formed on the lower substrate for covering the address electrodes; a barrier rib formed on the dielectric layer to form a discharge cell, with a width of a central portion thereof being narrower than each width of its upper and lower ends; and a fluorescent layer formed inside the discharge cell.

These and other objects of the present invention will be apparent from the following detailed description of the embodiments of the present invention with reference to the accompanying drawings. The following embodiments are just for exemplary purposes of the present invention, and are not intended to limit the scope defined by the claims attached.

### BRIEF DESCRIPTION OF THE DRAWINGS

The invention will be described in detail with reference to the following drawings in which like numerals refer to like elements.

FIG. 1 is an exploded perspective view illustrating a schematic configuration of a conventional AC plasma display panel.

FIG. 2 is a cross-sectional view illustrating a first embodiment of a lower structure of a plasma display panel.

FIG. 3 is a cross-sectional view illustrating a second embodiment of a lower structure of a plasma display panel.

FIG. 4 is a cross-sectional view illustrating a third embodiment of a lower structure of a plasma display panel.

FIGS. 5a to 5f illustrate cross-sectional views of an embodiment of a method for manufacturing a lower structure of a plasma display panel.

FIG. 6 is a schematic cross-sectional view illustrating a stamp applied to a process of FIG. 5c.

FIG. 7 is a cross-sectional view illustrating an embodiment of a plasma display panel.

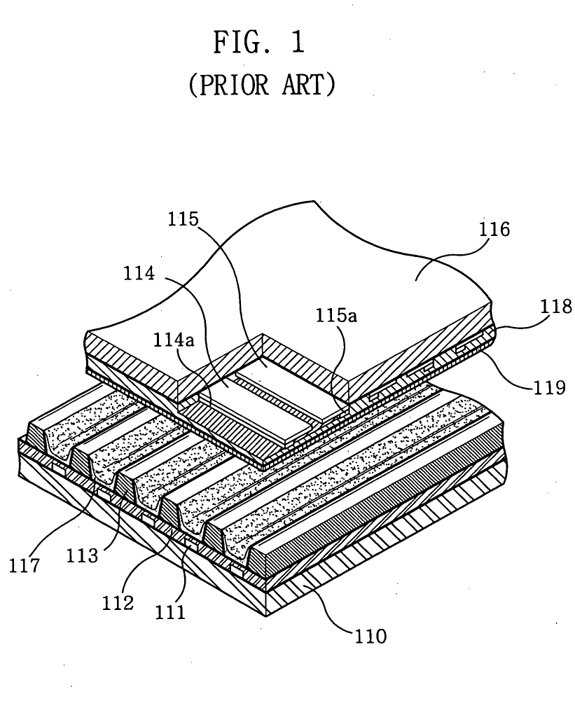

### DETAILED DESCRIPTION

Preferred embodiments will now be described in a more detailed manner with reference to the drawings.

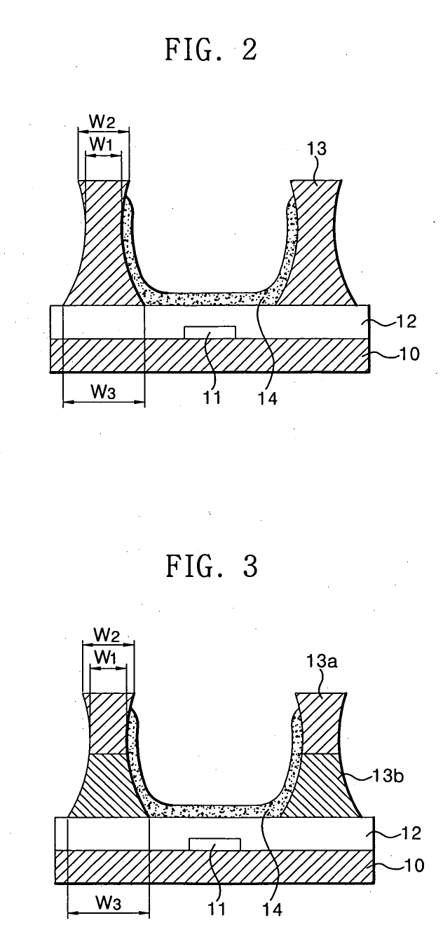

FIG. 2 is a cross-sectional view illustrating a first embodiment of a lower structure of a plasma display panel.

The lower structure includes an address electrode (11) formed on a lower substrate (10); a dielectric layer (12) formed on the lower substrate (10) for covering the address electrodes (11); a barrier rib (13) formed on the dielectric layer (12) to form a discharge cell, and a fluorescent layer formed inside the discharge cell, where the barrier rib (13) has a width (W1) of a central portion thereof that is narrower than each width (W2, W3) of upper and lower ends thereof.

The barrier rib may be formed with the width of the lower end being wider than that of the upper end. As a result, the barrier rib may be such a fashion that the width of the lower end> the width of the upper end> the width of the central portion thereof.

The barrier rib (13), designed to prevent electrical and optical cross-talk between the cells and to obtain an inner space, is generally formed with the same or like material as that of the dielectric layer (12).

As noted above, the temperature of discharge cells in the PDP increases due to heat radiated by discharge and ultraviolet rays, such that if the temperature inside the discharge cells increases, the energy of particles existing inside the cells increases to activate the motion of the particles, which in turn enhances the coupling between the positive charges and the negative charges. Furthermore, the wall charges not involved with the memory function, i.e., the wall charges on the lateral surface of the barrier rib and on the surface of the lower dielectric layer, increase to thereby allow forming an electric field, such that the wall charges either on the lateral surface of barrier ribs or on the surface of the lower dielectric layer couple with the positive charges or negative charges formed on the protective film.

The force generated between the charges is in inverse proportion to squared distance between the charges according to the Coulomb's law, such that the coupling between the charges decrease as the discharge space is enlarged. As a result, there arises a problem that the number of pixels formed on the same area decreases as the discharge cells grow increased.

In forming a barrier rib in the PDP, the width (W1) of the central portion of the barrier rib is so configured as to be smaller than the widths (W2, W3) of the upper and lower ends. That is, the barrier rib is concavely formed at both sides thereof in order to increase the discharge space without decreasing the number of pixels formed on the same area.

Preferably, the concaved portion of the barrier rib has a curved surface in order to facilitate the removal of a stamp (described later).

The appropriate height of the barrier rib is in the range of 95˜145 μm. Preferably, the width (W3) of the lower end of the barrier rib is wider than that (W2) of the upper end. It would be appropriate that the width (W2) of the upper end is in the range of 30˜60 μm, and the width (W3) of the lower end is in the range of 30˜100 μm. Although the width (W1) of the central portion varies according to the widths of the upper and lower ends, it would be proper that the width (W1) of the central portion is 0.9˜0.7 times the width (W2) of the upper end. As the width (W1) of the central portion decreases, the discharge space is enlarged to be more effective in preventing the high temperature erroneous discharge. However, there is a risk of the barrier rib being damaged by the shock or pressure if the width (W1) of the central portion is excessively reduced. 10

In the present exemplary embodiment, the ingredients forming the barrier rib are made of materials such as SiO₂, ZnO, PbO and B₂O₃. To be more specific, the ingredient include SiO₂ of 10˜30 wt % (weight percentage), ZnO of 10˜30 wt %, PbO of 5˜30 wt %, B₂O₃ of 10˜30 wt %, K₂O of 2˜10 wt %, Li₂O of 5 wt % or less, CaO of 1˜5 wt %, Na₂O of 3˜8 wt %, Al₂O₃ of 1˜5 wt %, and Sb₂O₃ of 2 wt % or less. Preferably, a composition ratio of SiO₂+ZnO+PbO+B₂O₃ is less than 85 wt % of a total composition. Further preferably, a ratio of PbO/(SiO₂+ZnO+B₂O₃) satisfies a range of 2/5˜5/4. These compositions and composition ratio may apply to the afore-mentioned dielectric layer.

Therefore, it is advantageous that the barrier rib formed with these compositions and a low dielectric constant can prevent delay of addressing time and reduce generation of wall charges not involved with the memory function to thereby enable to prevent the high temperature erroneous discharge. Although the barrier rib of a low dielectric constant formed with the afore-said compositions may have a dielectric constant of 6˜9, the composition ratio may be adjusted to allow the barrier rib to have a dielectric constant range of 1˜10.

The shape of the barrier rib is not restricted to a stripe type, but can be other closed types such as a closed type. The barrier ribs may be formed with mutually different heights.

The lower substrate (10) is a soda-lime glass substrate, and its composition includes SiO₂ of 70 wt %, Na₂O of 15 wt %, CaO of 10 wt %, and small amounts of Al₂O₃, K₂O and MgO.

The address electrode (11) is formed by evaporating metal substances on the lower substrate. Metals such as Au, Ag, Ni and Cu are largely used for the address electrode.

When mass of a total dielectric layer is given as 100 wt %, the dielectric layer (12) has a composition ratio of PbO of 60˜70 wt %, SiO₂ of 12˜17 wt %, B₂O₃ of 8˜15 wt %, ZnO of 5˜12 wt %, and Al₂O₃ of 0.1˜5 wt %. The dielectric layer may be formed using a screen printing method.

The screen printing method is performed by applying dielectric paste on a lower substrate and drying. A designated height of a dielectric layer formed by one time of printing is 15˜25 μm, such that repeated printings are needed in order to obtain a desired height of the dielectric layer.

The dielectric layer thus composed has a dielectric constant of 10˜15. A dielectric constant of a dielectric layer of an upper substrate in a conventional PDP is 15˜20, so preferably, a dielectric constant of a dielectric layer in a lower substrate is lower than that of the dielectric layer of the upper substrate.

As described above, in order to drive the conventional 3-electrode AC type PDP with a surface-discharge structure, a wall surface of the dielectric layer (or a wall surface of the protective layer) should maintain a predetermined voltage and a discharge is generated by a pulse voltage applied to the address electrode of the lower substrate, and the discharge is then erased. At this time, the dielectric layer covering the sustain electrode forms a high wall discharge to thereby lower the sustain voltage and the driving voltage during the plasma discharge as the dielectric capacity increases with the dielectric constant increasing. However, as the address electrode at the lower substrate functions to transmit an image signal to each cell inside the plasma panel, it is advantageous to employ if possible a dielectric layer of lower dielectric constant that is low in forming a wall discharge. The reason is that it is advantageous to embodiment of images of the PDP to swiftly discharge each cell inside the panel and then to erase.

The dielectric layer may be formed by a white back reflecting light radiated from the fluorescent layer. The white back serves to prevent degradation of luminescence by attenuating light when the light emitted from the fluorescent layer is emitted to a lower surface (rear surface) of the PDP.

The paste composite for a white back formation of a PDP includes powder, resin, plasticizer and solvent, and preferably, is composed of a power content of 65˜75 wt %, a resin content of 4˜15 wt % and a solvent content of 25˜35 wt %. The powder is made of a mixture containing a parent glass, Al₂O₃, TiO₂ and the like. The resin for making an easy adhesion between the powder and attachment to the white back may be used with ethyl cellulose and acryl, or a mixture of ethyl cellulose and acryl.

FIG. 3 is a cross-sectional view illustrating a second embodiment of a lower structure of a plasma display panel.

Referring to FIG. 3, the lower substrate comprises: an address electrode (11) formed on a lower substrate (10); a dielectric layer (12) formed on the lower substrate (10) for covering the address electrodes (11); a barrier rib (13) formed on the dielectric layer (12) to form a discharge cell; a high dielectric layer (13b) having a dielectric constant of 11˜15 defined by a fluorescent layer (14) formed inside the discharge cell with the barrier rib (13) having a width (W1) of a central portion thereof that is narrower than each width (W2, W3) of upper and lower ends thereof; and a low dielectric layer (13a) formed on the high dielectric layer (13b) and having a dielectric constant in the range of 1˜10.

This is a modified structure of a barrier rib having a low dielectric constant, and this modified structure may obtain an effect of disposing a barrier rib of a low dielectric constant by reducing a dielectric constant at an upper portion of the barrier rib, i.e., a portion adjacent to the protective layer.

The dielectric layer of a high dielectric constant of 11˜15 is a barrier rib composite consisting of PbO of 60˜70 wt %, SiO₂ of 12˜17 wt %, B₂O₃ of 8˜15 wt %, ZnO of 5˜12 wt %, and Al₂O₃ of 0.1˜5 wt %, and the dielectric layer of a low dielectric constant of 1˜10 is formed by the aforementioned barrier rib composite of low dielectric constant.

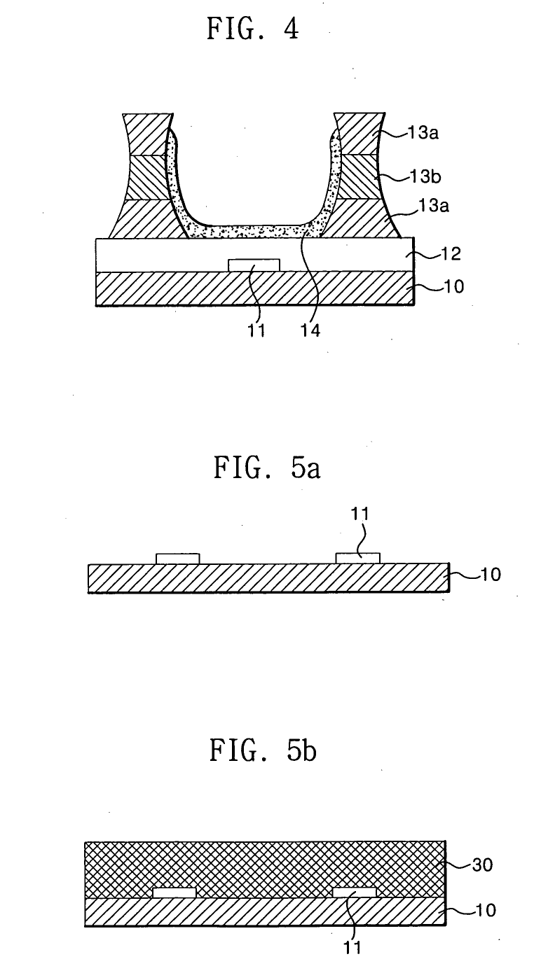

FIG. 4 is a cross-sectional view illustrating a third embodiment of a lower structure of a plasma display panel.

Referring to FIG. 4, the lower substrate comprises: an address electrode (11) formed on a lower substrate (10); a dielectric layer (12) formed on the lower substrate (10) for covering the address electrodes (11); a barrier rib (13) formed on the dielectric layer (12) to form a discharge cell; and a fluorescent layer (14) formed inside the discharge cell, wherein the barrier rib includes a high dielectric layer (13b) having a dielectric constant of 11˜15 and having a width of a central portion thereof that is narrower than each width of upper and lower ends thereof, and a low dielectric layer (13a) formed on upper and lower ends of the high dielectric layer (13b) and having a dielectric constant in the range of 1˜10. The present exemplary embodiment is a modified barrier rib having a low dielectric constant.

Hereinafter, a preferred method for fabricating a lower substrate of a plasma display panel will be described with reference to the accompanying drawings.

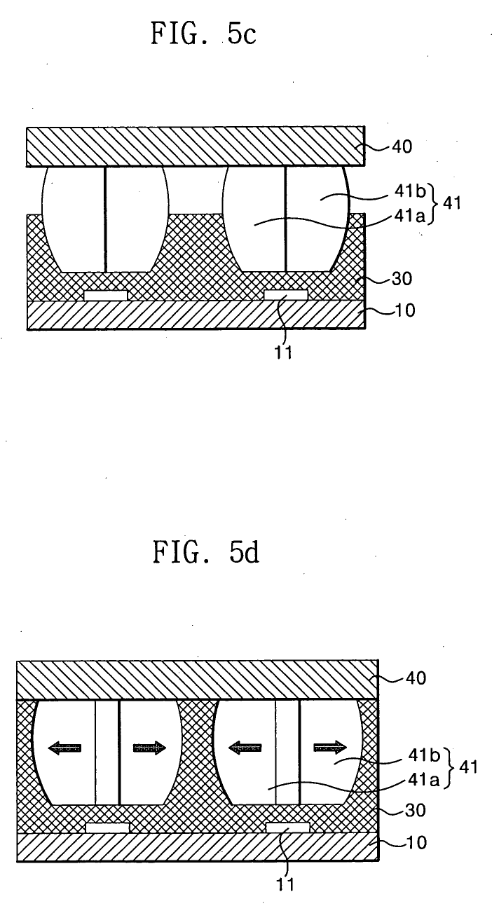

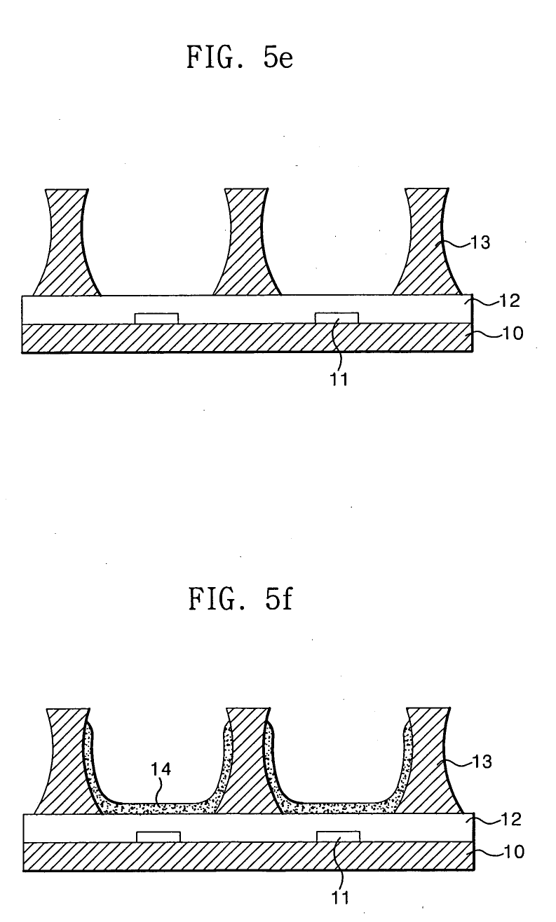

FIGS. 5a to 5f illustrate cross-sectional views of an embodiment of a method for manufacturing a lower structure of a plasma display panel, wherein the method for manufacturing a lower structure of a plasma display panel comprises: forming an address electrode (11) on a lower substrate (10) (FIG. 5a); applying a dielectric paste (30) on the lower substrate (10) to encompass the address electrode (11) (FIG. 5b); pressing the dielectric paste (30) by a stamp comprising a paired protrusion (41a, 41b) disposed at a support (40) for moving along the support (40) and a bottom surface of the support (40) to form a barrier rib (FIGS. 5c and 5d); separating the dielectric paste (30) from the stamp to plasticize the dielectric paste (30) and to complete a dielectric layer (12) and a barrier rib (13) (FIG. 5e); and forming a fluorescent layer (14) on a top surface of the dielectric layer (12) and a lateral surface of the barrier rib (13) (FIG. 5f), where the barrier rib has a width of a central portion thereof narrower than that of an upper end and a lower end.

First of all, the lower substrate (10) is formed with the address electrode (11) (FIG. 5a). The address electrode (11) may be formed by using a sputtering or printing method.

Next, a dielectric paste (30) is applied on the lower substrate (10) to encompass the address electrode (11) (FIG. 5b). The dielectric paste (30) may be formed with a composition ratio thereof by adjusting a dielectric constant in the range of 1˜10.

Successively, the dielectric paste (30) is pressed by a stamp composed of a paired protrusion (41a, 41b) disposed at a support (40) for moving along the support (40) and a bottom surface of the support (40) to form a barrier rib. To be more specific, the dielectric paste (30) is pressed by the stamp to a direction perpendicular to the upper surface of the lower substrate (10) (FIG. 5c), and then, the paired protrusion (41a, 41b) is moved to press the dielectric paste (30) to a direction parallel to the upper surface of the lower substrate (10) to form a barrier rib (FIG. 5d).

The barrier rib is centrally concaved, so it is difficult to form the barrier rib using a conventional stamp. Therefore, the method for fabricating a lower substrate of a plasma display panel is to use a protrusion (41) and the support (40), where the protrusion (41) consisting of a paired protrusion pattern each so separated as to move along the bottom surface of the support (40). First, the stamp is vertically pressed to form an approximate shape of a barrier rib, and then, the paired protrusion (41a, 41b) is moved to both lateral directions to form the shape of a barrier rib. A portion where the shape of a barrier rib is not formed naturally becomes a dielectric layer.

Thereafter, the stamp is separated from the dielectric paste (30), and the dielectric paste (30) is fired to complete the dielectric layer (12) and the barrier rib (13) (FIG. 5e). The protrusion of the stamp, so far having been distanced, is moved to join together, so that the stamp is easily separated without being obstructed by the upper end of the barrier rib.

The barrier rib and the dielectric layer are completed by plasticity. Preferably, the firing process is performed at 450˜600 degrees Celsius.

Successively, the fluorescent layer (14) is formed on the upper surface of the dielectric layer (12) and the lateral surface of the barrier rib (13) (FIG. 5f). The fluorescent layer (14) is formed by a screen printing or a sand blasting method.

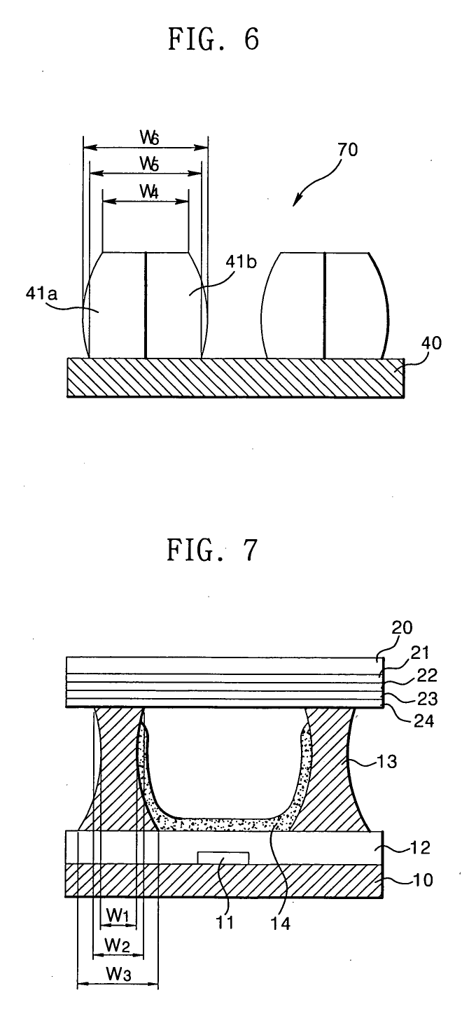

FIG. 6 is a schematic cross-sectional view illustrating a stamp applied to a process of FIG. 5c, where the stamp (70) for stamping the dielectric layer (12) consists of the support (40) and the paired protrusion (41a, 41b) disposed at the support (40) for moving along the bottom surface of the support (40).

At this time, when the paired protrusion (41a, 41b) is pressed on the dielectric paste, barrier ribs are formed on the dielectric paste, and a region where the paired protrusion (41a, 41b) is separated from the dielectric paste becomes a discharge cell. If a plurality of the paired protrusion (41a, 41b) is disposed at the support (40), all the discharge cells and barrier ribs required by a PDP may be formed on the dielectric paste by one time stamping process.

The mounting of the protrusion (41a, 41b) on the support (40) is not the subject matter of the present invention such that the mounting method may be freely designed.

Meanwhile, the protrusions of the paired protrusion (41a, 41b) are joined in a first process of the stamping, i.e., the process of FIG. 5c, where width (W6) of a central portion at the paired protrusion (41a, 41b) is formed to be wider than that of an upper end and a lower end (W4, W5). Therefore, when the stamping is finished, the dielectric paste is formed with a barrier rib whose central width is narrower than that of the upper end and the lower end. On the other hand, a region of the dielectric paste where the paired protrusion (41a, 41b) is separated may be formed with a discharge cell whose central width is wider than that of the upper end and the lower end, thereby enabling to increase a discharge space.

FIG. 7 is a cross-sectional view illustrating an embodiment of a plasma display panel, where the plasma display panel comprises: an upper structure formed under an upper substrate (20) with a sustain electrode (21), a bus electrode (22), a dielectric layer (23) and a protective film (24); and a lower structure coupled with the upper structure, wherein the lower structure comprises: an address electrode (11) formed on a lower substrate (10); a dielectric layer (12) formed on the lower substrate (10) for covering the address electrodes (11); a barrier rib (13) formed on the dielectric layer (12) to form a discharge cell, with a width (W1) of a central portion thereof being narrower than each width (W2, W3) of its upper and lower ends; and a fluorescent layer (14) formed inside the discharge cell.

The upper structure of the PDP formed under the upper substrate with the sustain electrode, the bus electrode, the dielectric layer and the protective film is a known upper structure of the PDP, such that a detailed description including its configuration and coupling relation thereto is omitted.

As apparent from the foregoing, there is an advantage in the lower structure of a plasma display panel in that a width of a central portion of a barrier rib is made to be narrower than each width of its upper and lower ends to allow having an increased discharge space, thereby reducing the high temperature erroneous discharge and enhancing reliability of the plasma display panel.

The lower structure of the plasma display panel is disposed with a barrier rib having a low dielectric constant to reduce the generation of wall charges and to prevent the generation of high temperature erroneous discharges.

The method for fabricating a lower structure of a plasma display panel employs a stamp formed with a support and a protrusion, where the protrusion is composed of a paired separated protruder movable under the support, enabling an easy formation of a barrier rib having a concave center portion.

Although the present invention has been explained by the embodiments shown in the drawings described above, it should be understood to the ordinary skilled person in the art that the invention is not limited to the embodiments, but rather that various changes or modifications thereof are possible without departing from the spirit of the invention. Accordingly, the scope of the invention shall be determined only by the appended claims and their equivalents.

What is claimed is:

1. A lower structure of a plasma display panel comprising: an address electrode formed on a lower substrate; a dielectric layer formed on the lower substrate for covering the address electrode; a barrier rib formed on the dielectric layer to form a discharge cell, with a width of a central portion thereof being narrower than each width of its upper and lower ends; and a fluorescent layer formed inside the discharge cell.

2. The structure as set forth in claim 1, wherein width of a central portion of the barrier rib is in the range of 0.9˜0.7 times the width of the upper end.

3. The structure as set forth in claim 1, wherein the dielectric constant of the barrier rib is in the range of 1˜10.

4. The structure as set forth in claim 1, wherein the barrier rib comprises: a high dielectric layer having a dielectric constant of 11˜15; and a low dielectric layer formed on the high dielectric layer and having a dielectric constant in the range of 1˜10.

5. The structure as set forth in claim 1, wherein the barrier rib comprises: a low dielectric layer having a dielectric constant of 1˜10; a high dielectric layer formed on the low dielectric layer and having a dielectric constant in the range of 11˜15; and a low dielectric layer formed on the high dielectric layer and having a dielectric constant in the range of 1˜10.

6. The structure as set forth in claim 1, wherein the dielectric layer is a white back for reflecting light emitted from the fluorescent layer.

7. The structure as set forth in claim 1, wherein height of the barrier rib is in the range of 95˜145 μm.

8. The structure as set forth in claim 1, wherein width of the upper end of the barrier rib is in the range of 30˜60 μm, and width of the lower end of the barrier rib is in the range of 30˜100 μm.

9. The structure as set forth in claim 1, wherein the width of the lower end of the barrier rib is wider than that of the upper end.

10. A plasma display panel comprising: an upper structure formed under an upper substrate with a sustain electrode, a bus electrode, a dielectric layer and a protective film; and a lower structure coupled with the upper structure, wherein the lower structure comprises: an address electrode formed on a lower substrate; a dielectric layer formed on the lower substrate for covering the address electrodes; a barrier rib formed on the dielectric layer to form a discharge cell, with a width of a central portion thereof being narrower than each width of its upper and lower ends; and a fluorescent layer formed inside the discharge cell.

11. The panel as set forth in claim 10, wherein the barrier rib is concavely formed at both sides thereof.

12. The panel as set forth in claim 11, wherein the barrier rib comprises: a high dielectric layer having a dielectric constant of 11˜15; and a low dielectric layer formed on the high dielectric layer and having a dielectric constant in the range of 1˜10.

13. The panel as set forth in claim 1, wherein the dielectric layer is a white back for reflecting light emitted from the fluorescent layer.

14. The panel as set forth in claim 11, wherein width of a central portion of the barrier rib is in the range of 0.9˜0.7 times the width of the upper end.

15. The panel as set forth in claim 11, wherein the dielectric constant of the barrier rib is in the range of 1˜10.

16. The panel as set forth in claim 11, wherein the concaved portion of the barrier rib has a curved surface.

17. A method for fabricating a lower structure of a plasma display panel comprising: forming an address electrode on a lower substrate; applying a dielectric paste on the lower substrate to encompass the address electrode; pressing the dielectric paste by stamp to form a barrier rib having a width of a central portion thereof narrower than that of an upper end and a lower end; separating the dielectric paste from the stamp to fire the dielectric paste and to complete a dielectric layer and a barrier rib; and forming a fluorescent layer on a top surface of the dielectric layer and a lateral surface of the barrier rib.

18. The method as set forth in claim 17, wherein the stamp comprises: a support; and a paired protrusion disposed at the support for moving along a bottom surface of the support.

19. The method as set forth in claim 18, wherein the step of separating the dielectric paste from the stamp to fire the dielectric paste and to complete a dielectric layer and a barrier rib further comprises: pressing the dielectric paste with the stamp to a direction perpendicular to the upper surface of the lower substrate; and moving the paired protrusion and pressing the dielectric paste to a direction parallel to the upper surface of the lower substrate to form a barrier rib.

20. The method as set forth in claim 17, wherein the dielectric layer is a white back for reflecting light emitted from the fluorescent layer.

21. The method as set forth in claim 17, wherein wherein the barrier rib is concavely formed at both sides thereof.
